(19) United States
(12) Patent Application Publication
(10) Pub. No.: US 2021/0117700 A1
(43) Pub. Date: Apr. 22, 2021

(54) LANE LINE ATTRIBUTE DETECTION

(71) Applicant: Beijing Sensetime Technology Development Co., Ltd., Beijing (CN)

(72) Inventors: Yashu ZHANG, Beijing (CN); Peiwen LIN, Beijing (CN); Guangliang CHENG, Beijing (CN); Jianping SHI, Beijing (CN)

(21) Appl. No.: 17/137,030

(22) Filed: Dec. 29, 2020

Related U.S. Application Data
(63) Continuation of application No. PCT/CN2020/076036, filed on Feb. 20, 2020.

(30) Foreign Application Priority Data
Jun. 25, 2019 (CN) 201910556260.X

(51) Int. Cl. G06K 9/00; G06K 9/46; G06K 9/62; G06T 7/13; G06T 5/00; G06N 3/08

(52) U.S. Cl. CPC G06K 9/00798; G06K 9/4604; G06K 9/6259; G06T 7/13; G06T 5/006; G06T 2207/20084; G06T 2207/30256; G06T 2207/10024; G06T 2207/20076; G06T 2207/20081; G06N 3/08

(57) ABSTRACT

Lane line attribute detection methods and apparatuses, electronic devices, and intelligent devices are provided. The method includes: obtaining a pavement image collected by an image acquisition device mounted on an intelligent device; determining probability maps according to the pavement image, wherein the probability maps include at least two sets of: color, line type, and edge attribute probability maps, each color attribute probability map represents probabilities of points in the pavement image belonging to a color corresponding to the color attribute probability map, each line type attribute probability map represents probabilities of points in the pavement image belonging to a line type corresponding to the line type attribute probability map, and each edge attribute probability map represents probabilities of points in the pavement image belonging to an edge corresponding to the edge attribute probability map; and determining a lane line attribute in the pavement image according to the probability maps.

### CROSS REFERENCE TO RELATED APPLICATIONS

The application is a continuation application of International Patent Application No. PCT/CN2020/076036 filed on Feb. 20, 2020, which is based on and claims priority to and benefit of China Patent Application No. 201910556260.X, filed on Jun. 25, 2019. The content of all of the above-identified applications is incorporated herein by reference in their entirety.

### TECHNICAL FIELD

The examples of the present disclosure relate to the computer technology, and in particular to lane line attribute detection methods and apparatuses, electronic devices, and intelligent devices.

### BACKGROUND

Assisted driving and automatic driving are two important technologies in the field of intelligent driving. Through assisted driving or automatic driving, a distance between vehicles may be reduced, occurrence of traffic accidents may be reduced, and burden on a driver may be eased. Therefore, assisted driving or automatic driving plays an important role in the field of intelligent driving. In the assisted driving technology and the automatic driving technology, a lane line attribute detection is required. The lane line attribute detection can be used to identify a type of a lane line on the road, such as a white solid line, a white dashed line, and so on. Based on a detection result of the lane line attribute, operations such as path planning, path deviation warning, traffic analysis, and so on, can be performed, and reference for precise navigation is also provided.

Therefore, lane line attribute detection is of great significance to the assisted driving and the automatic driving. How to perform accurate and efficient lane line attribute detection is an important topic worthy of research.

### SUMMARY

Examples of the present disclosure provide technical solutions for lane line attribute detection.

In a first aspect of the examples of the present disclosure, a lane line attribute detection method is provided, the method includes:

obtaining a pavement image collected by an image acquisition device mounted on an intelligent device; determining probability maps according to the pavement image, wherein the probability maps include at least two of: a set of color attribute probability maps, a set of line type attribute probability maps, and a set of edge attribute probability maps, where, there are N1 color attribute probability maps, N2 line type attribute probability maps, and N3 edge attribute probability maps, N1, N2, and N3 are all integers greater than 0; each of the color attribute probability maps represents a probability of each point in the pavement image belonging to a color corresponding to the color attribute probability map, each of the line type attribute probability maps represents a probability of each point in the pavement image belonging to a line type corresponding to the line type attribute probability map, and each of the edge attribute probability maps represents a probability of each point in the pavement image belonging to an edge corresponding to the edge attribute probability map; and determining an attribute of a lane line in the pavement image according to the probability maps.

In a second aspect of the examples of the present disclosure, a lane line attribute detection apparatus is provided, the apparatus includes:

a first obtaining module configured to obtain a pavement image collected by an image acquisition device mounted on an intelligent device; a first determining module configured to determine probability maps according to the pavement image, wherein the probability maps include at least two of: a set of color attribute probability maps, a set of line type attribute probability maps, and a set of edge attribute probability maps, where, there are N1 color attribute probability maps, N2 line type attribute probability maps, and N3 edge attribute probability maps, N1, N2, and N3 are all integers greater than 0; each of the color attribute probability maps represents a probability of each point in the pavement image belonging to a color corresponding to the color attribute probability map, each of the line type attribute probability maps represents a probability of each point in the pavement image belonging to a line type corresponding to the line type attribute probability map, and each of the edge attribute probability maps represents a probability of each point in the pavement image belonging to an edge corresponding to the edge attribute probability map; and a second determining module configured to determine an attribute of a lane line in the pavement image according to the probability maps.

In a third aspect of the examples of the present disclosure, an electronic device is provided, the electronic device includes:

a memory for storing program instructions, and a processor configured to invoke and execute the program instructions in the memory to implement the method steps described in the first aspect.

In a fourth aspect of the examples of the present disclosure, an intelligent driving method is provided, the method is applicable to an intelligent device, and the method includes:

obtaining a pavement image; detecting an attribute of a lane line in the obtained pavement image by using the lane line attribute detection method described in the first aspect; and outputting prompt information or performing driving control on the intelligent device according to the detected attribute of the lane line.

In a fifth aspect of the examples of the present disclosure, an intelligent device is provided, the intelligent device includes:

an image acquisition device configured to collect a pavement image; a memory configured to store program instructions, wherein the program instructions are executed to implement the lane line attribute detection method described in the first aspect; and a processor configured to detect an attribute of a lane line in the pavement image by executing the program instructions stored in the memory according to the pavement image collected by the image acquisition device, and output prompt information or perform driving control on the intelligent device according to the detected attribute of the lane line.

In a sixth aspect of the examples of the present disclosure, a non-transitory readable storage medium is provided, the readable storage medium stores a computer program, and the computer program is configured to execute the method steps described in the first aspect.

In the lane line attribute detection methods and apparatuses, electronic devices, and intelligent devices provided by the examples of the present disclosure, an attribute of a lane line is divided into three dimensions: color, line type, and edge, and then points in the obtained pavement image can be used to determine three sets of attribute probability maps in these three dimensions. Based on at least two of the three sets of attribute probability maps, the attribute of the lane line in the pavement image can be determined. Since the three sets of attribute probability maps obtained in the above process each address one dimension of the attribute of the lane line, determining various probability maps based on the pavement image can be considered as a single task detection, which reduces complexity of a detection task. The attribute of the lane line in the pavement image is then determined from a result of each task detection, that is, the attribute of the lane line is obtained by combining the results of the various detections. Therefore, when there are many types of the lane line attribute, or when the lane line attribute is to be determined in detail, the lane line attribute detection methods provided in the examples of the present disclosure improve accuracy and robustness of predicting the lane line attribute in a manner of separately detecting different attributes for the lane line and then combining the detection results. In this way, when the method is applicable to a scene with higher complexity, a more accurate lane line attribute detection result can be obtained.

### BRIEF DESCRIPTION OF THE DRAWINGS

FIG. 1 is a schematic scene diagram illustrating a lane line attribute detection method according to an example of the present disclosure.

FIG. 2 is a flowchart illustrating a lane line attribute detection method according to an example of the present disclosure.

FIG. 3 is a flowchart illustrating a lane line attribute detection method according to another example of the present disclosure.

FIG. 4 is a flowchart illustrating a lane line attribute detection method according to still another example of the present disclosure.

FIG. 5 is a flowchart illustrating a method of training a neural network for detecting an attribute of a lane line according to an example of the present disclosure.

FIG. 6 is a schematic structural diagram illustrating a convolutional neural network according to an example of the present disclosure.

FIG. 7 is a flowchart illustrating a process of performing pavement image processing by a neural network for detecting an attribute of a lane line according to an example of the present disclosure.

FIG. 8 is a module structural diagram illustrating a lane line attribute detection apparatus according to an example of the present disclosure.

FIG. 9 is a module structural diagram illustrating a lane line attribute detection apparatus according to another example of the present disclosure.

FIG. 10 is a schematic structural diagram illustrating an electronic device according to an example of the present disclosure.

FIG. 11 is a schematic structural diagram illustrating an intelligent device according to an example of the present disclosure.

FIG. 12 is a flowchart illustrating an intelligent driving method according to an example of the present disclosure.

### DETAILED DESCRIPTION OF THE EMBODIMENTS

To make the objects, technical solutions and advantages of the present disclosure clearer, the technical solutions in the embodiments of the present disclosure will be described clearly and completely below with reference to the accompanying drawings in the embodiments of the present disclosure. Apparently, the described embodiments are a part of the embodiments of the present disclosure rather than all of the embodiments. Based on the embodiments of the present disclosure, all other embodiments obtained by those skilled in the art without creative efforts all belong to the scope of protection of the present disclosure.

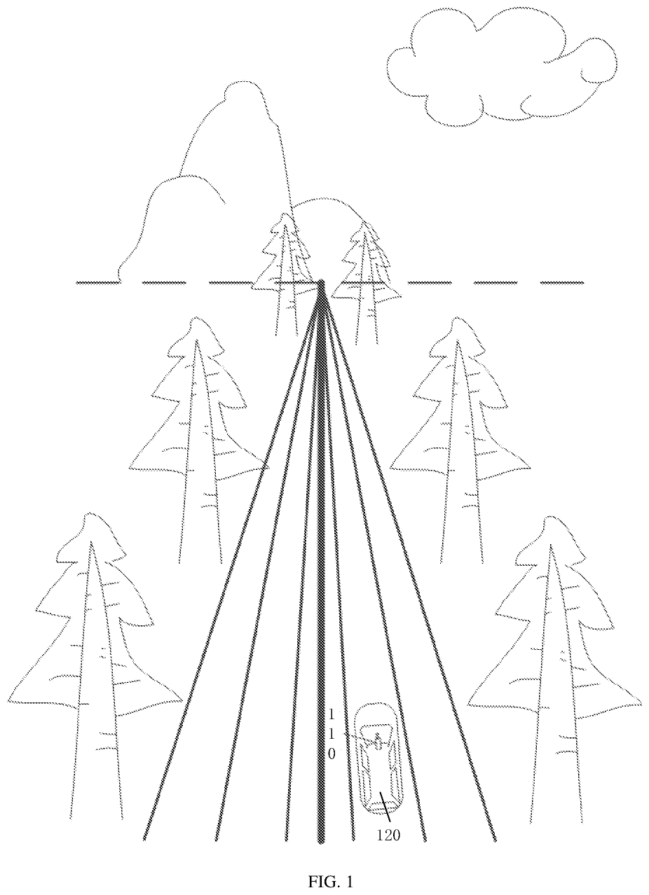

FIG. 1 is a schematic scene diagram illustrating a lane line attribute detection method according to an example of the present disclosure. As shown in FIG. 1, the method can be applicable to a vehicle 120 equipped with an image acquisition device 110. The image acquisition device 110 may be a device with a photographing function, such as, a camera, a dash camera, and the like, mounted on the vehicle 120. When the vehicle is on the road, one or more images of a pavement are captured by the image acquisition device on the vehicle, and an attribute of a lane line on the road wherein the vehicle is located is detected based on methods provided by the present disclosure, such that the obtained detection result can be used in assisted driving or automatic driving, such as, path planning, path deviation warning, traffic analysis, etc.

In some examples, the lane line attribute detection methods provided by the present disclosure are also applicable to an intelligent device that requires roadway recognition, such as a robot, a guidance device for the blind, or the like.

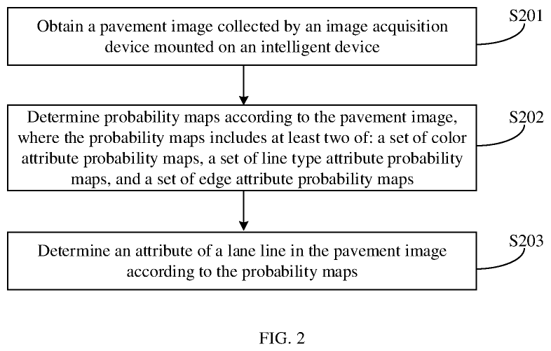

FIG. 2 is a flowchart illustrating a lane line attribute detection method according to an example of the present disclosure. As shown in FIG. 2, the method includes steps S201-S203.

S201, a pavement image collected by an image acquisition device mounted on an intelligent device is obtained.

Taking the intelligent device being a vehicle as an example, the image acquisition device mounted on the vehicle can capture one or more real-time images of a pavement on which the vehicle is traveling. Further, with subsequent steps, continuously updated lane line attribute detection results can be obtained based on the pavement images collected by the image acquisition device.

S202, probability maps are determined according to the pavement image.

The probability maps include at least two of: a set of color attribute probability maps, a set of line type attribute probability maps, and a set of edge attribute probability maps.

There are N1 color attribute probability maps, each of the color attribute probability maps corresponds to one color, and N1 color attribute probability maps correspond to N1 colors. There are N2 line type attribute probability maps, each of the line type attribute probability maps corresponds to one line type, and the N2 line type attribute probability maps correspond to N2 line types. There are N3 edge attribute probability maps, each of the edge attribute probability maps corresponds to one edge type, and the N3 edge attribute probability maps correspond to N3 edge types. Each of the color attribute probability maps represents a probability of each point in the pavement image belonging to a corresponding color, each of the line type attribute probability maps represents a probability of each point in the pavement image belonging to a corresponding line type, and each of the edge attribute probability maps represents a probability of each point in the pavement image belonging to a corresponding edge. N1, N2, and N3 are all integers greater than 0.

In some examples, the probability maps can be determined by a neural network. The pavement image is input into the neural network, and the neural network outputs the probability maps. The neural network may include, but is not limited to, a convolutional neural network.

In the examples of the present disclosure, the attribute of the lane line is split to the three dimensions: color, line type, and edge, and the neural network predicts probability maps in at least two of these three dimensions, wherein each of the probability maps is for respective points in the pavement image.

In an example, in the color dimension, the N1 colors may include at least one of the following: white, yellow, or blue. In addition to these three colors, in the color dimension, it may include two more results: no lane line and other color, that is, the no lane line and other color are also treated as one color each. The no lane line indicates that a point in the pavement image does not belong to a lane line. The other color indicates that a color of a point in the pavement image is a color other than white, yellow, and blue.

Table 1 shows an example of the above color types in the color dimension. As shown in Table 1, 5 color types are included in the color dimension, and a value of N1 is 5.

TABLE 1

| Type number | 0 | 1 | 2 | 3 | 4 |
|---|---|---|---|---|---|
| Type name | No lane line | Other color | White | Yellow | Blue |

In an example, in the line type dimension, the N2 line types may include at least one of the following: a dashed line, a solid line, a double dashed line, a double solid line, a dashed solid line, a solid dashed line, a triple dashed line, and a dashed solid dashed line. In addition to these line types, in the line type dimension, it may include two more results: no lane line and other line type, that is, the no lane line and other line type are also regarded as one line type each. The no lane line indicates that a point in the pavement image does not belong to a lane line. The other line type indicates that a line type of a point in the pavement image is a line type other than the above line types. The dashed solid line may refer to, in a left-to-right direction, a first line being a dashed line and a second line being a solid line. Correspondingly, the solid dashed line may refer to, in the left-to-right direction, a first line being a solid line and a second line being a dashed line.

Table 2 shows an example of the above line types in the line type dimension. As shown in Table 2, 10 line types are included in the line type dimension, and a value of N2 is 10.

TABLE 2

| | Type number | | | | | | | | | |
|---|---|---|---|---|---|---|---|---|---|---|
| | 0 | 1 | 2 | 3 | 4 | 5 | 6 | 7 | 8 | 9 |
| Type name | No lane | Other | Dashed | Solid | Double | Double | Dashed | Solid | Triple | Dashed |
| | line | line type | line | line | dashed line | solid line | solid line | dashed line | dashed line | solid |
| | | | | | | | | | | dashed |
| | | | | | | | | | | line |

In an example, in the edge dimension, the N3 edges may include at least one of the following: a curb type edge, a fence type edge, a wall or flower bed type edge, a virtual edge, and non-edge. The non-edge indicates that a point in the pavement image does not belong to an edge, but belongs to a lane line. In addition to these edge types, in the edge dimension, it may include two more results: no lane line and other edge, that is, the no lane line and other edge are also regarded as one edge type each. The no lane line indicates that a point in the pavement image does not belong to a lane line or an edge. The other edge indicates that a point in the pavement image belongs to an edge type other than the above edge types.

Table 3 shows an example of the above edge types in the edge type dimension. As shown in Table 3, 7 edge types are included in the edge dimension, and a value of N3 is 7.

TABLE 3

| | Type number | | | | | | |
|---|---|---|---|---|---|---|---|
| | 0 | 1 | 2 | 3 | 4 | 5 | 6 |
| Type | No | Non- | Other | Curb | Fence | Wall or | Virtual |
| name | lane | edge | edge | type | type | flower | edge |
| | line | | | edge | edge | bed type | |
| | | | | | | edge | |

Take types of respective attributes shown in Table 1, Table 2 and Table 3 above as an example, in this step, after the pavement image is input to the neural network, the neural network can output 5 color attribute probability maps, 10 line type attribute probability maps, and 7 edge attribute probability maps. Each of the 5 color attribute probability maps represents a probability that each point in the pavement image belongs to one of the colors in Table 1. Each of the 10 line type attribute probability maps represents a probability that each point in the pavement image belongs to one of the line types in Table 2. Each of the 7 edge attribute probability maps represents a probability that each point in the pavement image belongs to one of the edges in Table 3.

Taking the color type as an example, it is assumed that the numbering shown in Table 1 is used and the 5 color attribute probability maps are probability map 0, probability map 1, probability map 2, probability map 3, and probability map 4. Then a correspondence between color attribute probability map and color type in Table 1 can be shown in Table 4.

TABLE 4

| Color attribute | Probability | Probability | Probability | Probability | Probability |
|---|---|---|---|---|---|
| probability map | map 0 | map 1 | map 2 | map 3 | map 4 |
| Color type | No lane line | Other color | White | Yellow | Blue |

Further, based on the correspondence shown in Table 4, Exemplarily, probability map 2 can identify a probability of each point in the pavement image belonging to white. Assuming that the pavement image is represented as a matrix of 200*200, after inputting the matrix into the neural network, another matrix of 200*200 can be output by the neural network, wherein a value of each element in the output matrix represents a probability of a point at a corresponding position in the pavement image being white. For example, in the matrix of 200*200 output by the neural network, a value of an element in row 1 column 1 is 0.4, which means that a probability of a point in row 1 column 1 in the pavement image belonging to a white type is 0.4. Further, the matrix output by the neural network may be represented in a form of a color attribute probability map.

S203, an attribute of a lane line in the pavement image is determined according to the probability maps.

It should be noted that, in the examples of the present disclosure, the set of color attribute probability maps, the set of line type attribute probability maps, and the set of edge attribute probability maps belong to three sets of probability maps, and when one set of the probability maps is used, a plurality of probability maps in this set of probability map may be used simultaneously. For example, a color attribute of the pavement image can be determined simultaneously by using the N1 color attribute probability maps in the set of color attribute probability maps.

In an example approach, the probability maps may be two sets in the set of color attribute probability maps, the set of line type attribute probability maps, and the set of edge attribute probability maps. That is, any two sets in the sets of color attribute probability maps, line type attribute probability maps, and edge attribute probability maps may be used to determine an attribute of a lane line in the pavement image.

In this approach, when determining the lane line attribute in the pavement image, a number of lane line attribute is a number of combinations of attributes which correspond to the two used probability map sets respectively, and each lane line attribute is a combination of one attribute from each of the two used probability map set.

Exemplarily, the set of color attribute probability maps and the set of line type attribute probability maps are used to determine the lane line attribute in the pavement image, wherein a number of the set of color attribute probability maps is N1 and a number of the set of line type attribute probability maps is N2, then, the number of lane line attribute determined in the pavement image is N1*N2. A lane line attribute is a combination of a color attribute and a line type attribute, i.e., a lane line attribute includes a color attribute and a line type attribute. For example, a lane line attribute is a white dashed line, which is a combination of white and a dashed line.

In another approach, the probability maps may be the three sets of color attribute probability maps, line type attribute probability maps, edge attribute probability maps. That is, the set of color attribute probability maps, the set of line type attribute probability maps, and the set of edge attribute probability maps may be used simultaneously to determine an attribute of a lane line in the pavement image.

In this approach, when determining the lane line attribute in the pavement image, a number of lane line attribute is a number of combinations of attributes which correspond to the three used probability map sets respectively, and each lane line attribute is a combination of one attribute from each of the three used probability map sets.

Exemplarily, a number of the set of color attribute probability maps is N1, a number of the set of line type attribute probability maps is N2, a number of the set of edge attribute probability maps is N3, then the number of lane line attribute determined in the pavement image is N1*N2*N3. A lane line attribute is a combination of a color attribute, a line type attribute, and an edge attribute, i.e., a lane line attribute includes a color attribute, a line type attribute, and an edge attribute. For example, a lane line attribute is a white dashed road line, which is a combination of white, a dashed line, and non-edge.

It should be noted that, the above N1*N2*N3 refers to all combinations that can be supported by the present disclosure, and that some combinations may not be present in actual use during specific implementation.

Processes of implementing the above approaches are described in detail in the following examples.

In the examples, an attribute of a lane line is divided into three dimensions: color, line type, and edge, and then three sets of attribute probability maps in these three dimensions for each point in the pavement image can be obtained. Based on at least two of the three sets of attribute probability maps, the attribute of the lane line in the pavement image can be determined. Since the three sets of attribute probability maps obtained in the above process each address one dimension of the attribute of the lane line, determining various probability maps based on the pavement image can be considered as a single task detection, which reduces complexity of a detection task. The attribute of the lane line in the pavement image is then determined from a result of each task detection, that is, the attribute of the lane line is obtained by combining the results of the various detections. Therefore, when there are many types of the lane line attribute, or when the lane line attribute is to be determined in detail, the lane line attribute detection methods provided in the examples of the present disclosure improves accuracy and robustness of predicting the lane line attribute in a manner of separately detecting different attributes for the lane line and then combining the detection results. In this way, when the method is applicable to a scene with higher complexity, a more accurate lane line attribute detection result can be obtained. In addition, in the present disclosure, an edge is used as an attribute dimension, such that the methods of the present disclosure not only can accurately detect a lane type in a structured road scenario wherein lane markings are identified, but also can accurately detect various types of edge types in a scenario wherein the lane markings are missing or not identified, for example, in a scene of driving on a rural road.

On basis of the above examples, the present example specifically describes a process of using probability maps to determine a lane line attribute in a pavement image.

In an example approach, the probability maps may be two sets in the set of color attribute probability maps, the set of line type attribute probability maps, and the set of edge attribute probability maps.

In an example, the probability maps used in the above step S203 includes a set of first attribute probability maps and a set of second attribute probability maps. The set of first attribute probability maps and the set of second attribute probability maps are two sets in the set of color attribute probability maps, the set of line type attribute probability maps, and the set of edge attribute probability maps, and the set of first attribute probability maps is different set with the set of second attribute probability maps.

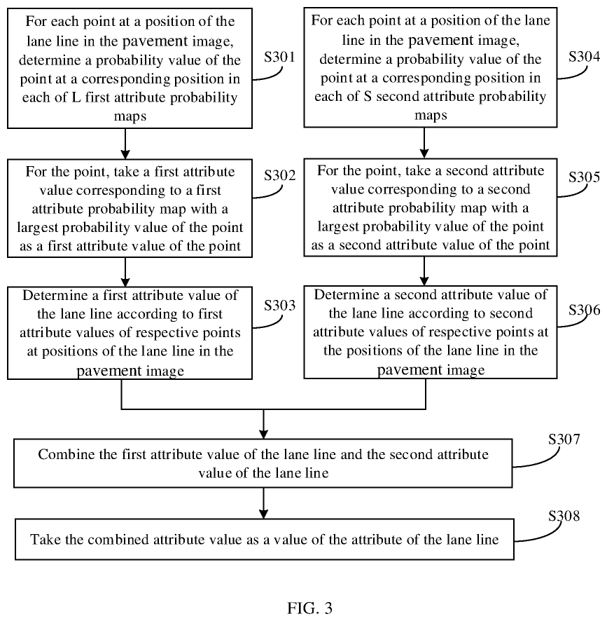

FIG. 3 is a flowchart illustrating a lane line attribute detection method according to another example of the present disclosure. As shown in FIG. 3, when the probability maps include the set of first attribute probability maps and the set of second attribute probability maps, at the above step S203, a process of determining the attribute of the lane line in the pavement image according to the probability maps includes the following steps.

S301, for each point at a position of the lane line in the pavement image, a probability value of the point at a corresponding position is determined in each of L first attribute probability maps.

S302, for the point, a first attribute value corresponding to a first attribute probability map with a largest probability value of the point is taken as a first attribute value of the point.

S303, a first attribute value of the lane line is determined according to first attribute values of respective points at positions of the lane line in the pavement image.

Before performing step S301, the pavement image can be pre-processed to obtain one or more lane lines in the pavement image. For example, the pavement image may be input to a trained neural network, and the neural network outputs a lane line result in the pavement image. For another example, the pavement image can be input to a trained semantic segmentation network, and the semantic segmentation network outputs a lane line segmentation result in the pavement image. The attribute of the lane line is then calculated using the method shown in FIG. 3 to process the lane line. Thus, accuracy of lane line recognition is improved.

The first attribute value of the lane line in the pavement image can be determined using steps S301 to S303. The first attribute is an attribute corresponding to the first attribute probability map. Exemplarily, the set of first attribute probability maps is the set of color attribute probability maps, then the first attribute is a color attribute, and the first attribute value may be white, yellow, blue, other color, etc.

Take the probability maps obtained by a neural network as an example. In this process, after the pavement image is input to the neural network, the neural network can output L first attribute probability maps. For a point at a lane line in the pavement image, there is a probability value of a corresponding position in each first attribute probability map. The greater the probability value, the greater the probability that the point belongs to an attribute corresponding to the probability map. Therefore, for the point, the probability values of the corresponding position in the L first attribute probability maps can be compared, and a first attribute value corresponding to a first attribute probability map having the largest probability value can be taken as the first attribute value of the point.

Exemplarily, assuming that the set of first attribute probability maps is the set of color attribute probability maps, the first attribute is a color attribute, and L is 5, that is, 5 color attribute probability maps are included, which are probability map 0, probability map 1, probability map 2, probability map 3, and probability map 4 as shown in Table 4 above, and each probability map corresponds to a color attribute. Assuming that a point at the lane line in the pavement image has the largest probability value in probability map 1, it can be determined that a color attribute value of the point is a color attribute corresponding to probability map 1.

Using this method, first attribute values of respective points at positions of the lane line in the pavement image can be obtained, and based on this, the first attribute value of the lane line can be determined according to the first attributes of the respective points.

For example, if the first attribute values of the respective points at the positions of the lane line are different, a first attribute value of points, which, among the respective points at the positions of the lane line, belong to a greatest number of points with an identical first attribute value, is taken as the first attribute value of the lane line.

Exemplarily, assuming that the first attribute is a color attribute, among the respective points at the lane line, a number of points with the first attribute being white accounts for 80% of a total number of points, a number of points with the first attribute being yellow accounts for 17% of the total number of points, and a number of points with the first attribute being other color accounts for 3% of the total number of points, white can be taken as the first attribute value of the lane line, i.e., the color attribute value.

For another example, if the first attribute values of the respective points at the positions of the lane line are the same, a first attribute of a point at any position of the lane line is taken as the first attribute value of the lane line.

Exemplarily, assuming that the first attribute is a color attribute and the first attribute values of all points at the positions of the lane line are yellow, yellow can be taken as the first attribute value of the lane line, that is, the color attribute value.

S304, for each point at a position of the lane line in the pavement image, a probability value of the point at a corresponding position is determined in each of S second attribute probability maps.

S305, for the point, a second attribute value corresponding to a second attribute probability map with a largest probability value of the point is taken as a second attribute value of the point.

S306, a second attribute value of the lane line is determined according to second attribute values of respective points at the positions of the lane line in the pavement image.

The second attribute value of the lane line in the pavement image can be determined using steps S304 to S306. The second attribute is an attribute corresponding to the second attribute probability map. Exemplarily, the set of second attribute probability maps is the set of line type attribute probability maps, then the second attribute is a line type attribute, and the second attribute value may be a solid line, a dashed line, a double solid line, a double dashed line, etc.

Take the probability maps obtained by a neural network as an example. In this process, after the pavement image is input to the neural network, the neural network can output S second attribute probability maps. For a point at a lane line in the pavement image, there is a probability value of a corresponding position in each second attribute probability map. The greater the probability value, the greater the probability that the point belongs to an attribute corresponding to the probability map. Therefore, for the point, the probability values of the corresponding position in the S second attribute probability maps can be compared, and a second attribute value corresponding to a second attribute probability map having the largest probability value can be taken as the second attribute value of the point.

Exemplarily, assuming that the set of second attribute probability maps is the set of line type attribute probability maps, the second attribute is a line type attribute, and S is 10, that is, 10 line type attribute probability maps are included, and each probability map corresponds to a line type attribute. Assuming that a point at the lane line in the pavement image has the largest probability value in a first line type probability map, it can be determined that a line type attribute value of the point is a line type attribute corresponding to the first line type probability map.

Using this method, second attribute values of respective points at positions of the lane line in the pavement image can be obtained, and based on this, the second attribute value of the lane line can be determined according to the second attributes of the respective points.

For example, if the second attribute values of the respective point at the positions of the lane line are different, a second attribute value of points, which, among the respective points at the positions of the lane line, belong to a greatest number of points with an identical second attribute value, is taken as the second attribute value of the lane line.

Exemplarily, assuming that the second attribute is a line type attribute, among the respective points at the lane line, a number of points with the second attribute being a solid line accounts for 81% of a total number of points, a number of points with the second attribute being a dashed line accounts for 15% of the total number of points, and a number of points with the second attribute being other line type accounts for 4% of the total number of points, the solid line can be taken as the second attribute value of the lane line, i.e., the line type attribute value.

For another example, if the second attribute values of the respective points at the positions of the lane line are the same, a second attribute of a point at any position of the lane line is taken as the second attribute value of the lane line.

Exemplarily, assuming that the second attribute is a line type attribute, and the second attribute values of all points at the positions of the lane line are a solid line, the solid line can be taken as the second attribute value of the lane line, that is, the lane line attribute value.

It should be noted that the above steps S301-S303 are executed in sequence, and the above steps S304-S306 are executed in sequence, while the execution sequences of S301-S303 and S304-S306 are not limited in the examples of the present disclosure. It may execute S301-S303 first, then execute S304-S306; or it may execute S304-S306 first, then execute S301-S303; or S301-S303 and S304-S306 may be executed in parallel.

In the above steps S301-S306, there are L first attribute probability maps, and S second attribute probability maps. As mentioned above, there are N1 color attribute probability maps, N2 line type attribute probability maps, and N3 edge attribute probability maps. The relationship between L, S and N1, N2, and N3 is as follows.

When the set of first attribute probability maps is the set of color attribute probability maps, L equals N1, and the first attribute is the color attribute. When the set of first attribute probability maps is the set of line type attribute probability maps, L equals N2, and the first attribute is the line type attribute. When the set of first attribute probability maps is the set of edge attribute probability maps, L equals N3, and the first attribute is the edge attribute. When the set of second attribute probability maps is the set of color attribute probability maps, S equals N1, and the second attribute is the color attribute. When the set of second attribute probability maps is the set of line type attribute probability maps, S equals N2, and the second attribute is the line type attribute. When the set of second attribute probability maps is the set of edge attribute probability maps, S equals N3, and the second attribute is the edge attribute.

It should be noted that since the set of first attribute probability maps is different set from the set of second attribute probability maps, when the set of first attribute probability maps is the set of color attribute probability maps, the second set of attribute probability maps can be the set of line type attribute probability maps or the set of edge attribute probability maps; when the set of first attribute probability maps is the set of line type attribute probability maps, the set of second attribute probability maps can be the set of color attribute probability maps or the set of edge attribute probability maps; and when the set of first attribute probability maps is the set of edge attribute probability maps, the set of second attribute probability maps can be the set of color attribute probability maps or the set of line type attribute probability maps.

S307, the first attribute value of the lane line and the second attribute value of the lane line are combined.

S308, the combined attribute value is taken as a value of the attribute of the lane line.

For example, after obtaining the first and second attribute values of a lane line, the first and second attribute values can be combined, such that the combined attribute value can be used as the attribute value of the lane line. A combination processing may be, for example, placing the second attribute value after the first attribute value, or placing the first attribute value after the second attribute value.

Exemplarily, assuming that the first attribute is the color attribute and the second attribute is the line type attribute, after the above steps, it is obtained that the first attribute value of a specific lane line in the pavement image is white, and the second attribute value of the lane line is a solid line. Then, upon placing the second attribute value after the first attribute value, a “white solid line” can be obtained, and the “white solid line” is the attribute value of the lane line.

In an example, the set of color attribute probability maps, the set of line attribute probability maps, and the set of edge attribute probability maps can be used simultaneously to determine the lane line attribute in the pavement image.

In this approach, the probability maps used in step S203 above include a set of third attribute probability maps in addition to the set of first attribute probability maps and the set of second attribute probability maps. The set of third attribute probability maps is one set from the sets of color attribute probability maps, line type attribute probability maps, and edge attribute probability maps. Any two of the set of first attribute probability maps, the set of second attribute probability maps, and the set of third attribute probability maps are sets of probability maps with different attributes.

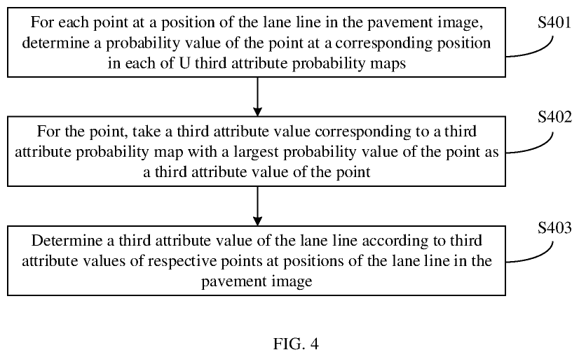

FIG. 4 is a flowchart illustrating a lane line attribute detection method according to still another example of the present disclosure. As shown in FIG. 4, the probability maps include the set of first attribute probability maps, the set of second attribute probability maps, and the set of third attribute probability maps. Before combining the first attribute value and the second attribute value in step S307 above, the following steps may also be performed.

S401, for each point at a position of the lane line in the pavement image, a probability value of the point at a corresponding position is determined in each of U third attribute probability maps.

S402, for the point, a third attribute value corresponding to a third attribute probability map with a largest probability value of the point is taken as a third attribute value of the point.

S403, a third attribute value of the lane line is determined according to third attribute values of the respective points at the positions of the lane line in the pavement image.

The third attribute value of the lane line in the pavement image can be determined using steps S401 to S403. The third attribute is an attribute corresponding to the third attribute probability map. Exemplarily, the set of third attribute probability maps is the set of edge attribute probability maps, then the third attribute is an edge attribute, and the third attribute value may be a curb type edge, a fence type edge, a virtual edge, etc.

Take the probability maps obtained by a neural network as an example. In this process, after the pavement image is input to the neural network, the neural network can output U third attribute probability maps. For a point in a lane line in the pavement image, there is a probability value of a corresponding position in each third attribute probability map. The greater the probability value, the greater the probability that the point belongs to the corresponding attribute of the probability map. Therefore, for the point, the probability values of the corresponding position in the U third attribute probability maps can be compared, and a third attribute value corresponding to a third attribute probability map having the largest probability value can be taken as the third attribute value of the point.

Exemplarily, assuming that the set of third attribute probability maps is the set of edge attribute probability maps, the third attribute is the edge attribute, and U is 7, that is, 7 edge attribute probability maps are included, and each probability map corresponds to an edge attribute. Assuming that a point at the lane line in the pavement image has the largest probability value in a seventh edge probability map, it can be determined that an edge attribute value of the point is an edge attribute corresponding to the seventh edge probability map.

Using this method, third attribute values of respective points at positions of the lane line in the pavement image can be obtained, and based on this, the third attribute value of the lane line can be determined according to the third attributes of the respective points.

For example, if the third attribute values of the respective point at the positions of the lane line are different, a third attribute value of points, which, among the respective points at the positions of the lane line, belong to a greatest number of points with an identical third attribute value, is taken as the third attribute value of the lane line.

Exemplarily, assuming that the third attribute is an edge attribute, among the respective points at the lane line, a number of points with the third attribute being a curb edge accounts for 82% of a total number of points, a number of points with the third attribute being a virtual edge accounts for 14% of the total number of points, and a number of points with the third attribute being non-edge accounts for 4% of the total number of points, the curb edge can be taken as the third attribute value of the lane line, i.e., the edge attribute value.

For another example, if the third attribute values of the respective points at the positions of the lane line are the same, a third attribute of a point at any position of the lane line is taken as the third attribute value of the lane line.

Exemplarily, assuming that the third attribute is an edge attribute, and the third attribute values of all points at the positions of the lane line are a curb edge, the curb edge can be taken as the third attribute value of the lane line, that is, the edge attribute value.

It should be noted that, in a specific implementation process, the above steps S401-S403 are executed in sequence, and the execution sequences of S401-S403, S301-S303, and S304-S306 are not limited in the examples of the present disclosure. Exemplarily, it can execute S301-S303 first, then execute S304-S306, and then execute S401-S403; or it can execute S304-S306 first, then execute S301-S303, and then execute S401-S403; or it can execute S401-S403 first, then execute S304-S306, and then execute S301-S303; or S301-S303, S304-S306, and S401-S403 are executed in parallel.

In the above steps S401-S403, there are U third attribute probability maps. As mentioned above, there are N1 color attribute probability maps, N2 line type attribute probability maps, and N3 edge attribute probability maps. The relationship between U and N1, N2, and N3 is as follows.

When the set of third attribute probability maps is the set of color attribute probability maps, U equals N1, and the third attribute is the color attribute. When the set of third attribute probability maps is the set of line type attribute probability maps, U equals N2, and the third attribute is the line type attribute. When the set of third attribute probability maps is the set of edge attribute probability maps, U equals N3, and the third attribute is the edge attribute.

In an example, when the probability maps include the set of first attribute probability maps, the set of second attribute probability maps, and the set of third attribute probability maps, during combining the first attribute value and the second attribute value of the lane line in step S307, the first attribute value of the lane line, the second attribute value of the lane line, and the third attribute value of the lane line can be combined.

Exemplarily, a combination processing may be, for example, placing the third attribute value after the first attribute value and the second attribute value, or placing the third attribute value before the second attribute value and the first attribute value.

Exemplarily, assuming that the first attribute is the color attribute, the second attribute is the line type attribute and the third attribute is the edge attribute, after the above steps, it is obtained that the first attribute value of a specific lane line in the pavement image is white, the second attribute value of the lane line is a solid line, and the third attribute value of the lane line is non-edge. Then, upon placing the third attribute value after the second attribute and the first attribute, a “white solid line non-edge” can be obtained. As mentioned earlier, the non-edge indicates a line that does not belong to an edge, but belong to a lane line, so the lane line attribute obtained in this example is a white solid lane line.

The process of determining the lane line attribute in the pavement image according to the probability maps is described above. As described above, the probability maps can be obtained through a neural network. The pavement image can be input into the neural network, and the neural network can output the probability maps.

The following examples illustrate training and using processes of the neural network involved in the above examples.

Prior to using the neural network, the neural network may be supervised trained preemptively by adopting a pavement training image set, which includes pavement training images with annotation information as color type, line type, and edge type. The pavement training image set includes a large number of images for training. Each image for training may be obtained through a process of collecting an actual pavement image and annotating the actual pavement image. In an example, multiple actual pavement images under various scenarios such as daytime, nighttime, rain, tunnel, straight road, curve, intense illumination, etc., may be collected first, and then, for each actual pavement image, pixel-level annotation is performed. Types of each pixel in the actual pavement image is annotated with annotation information as color type, line type, and edge type, so as to obtain the training image set. Since parameters of the neural network are obtained by supervised training with the training image set collected from various scenes, the trained neural network can obtain accurate lane line attribute detection results not only in some simple scenes, such as a daytime scene with good weather and lighting conditions, but also in more complex scenes, such as in rain, night, tunnels, curves, intense illumination, etc.

The training image set involved in the above process covers a variety of scenarios in practice, therefore, the neural network trained using the training image set has good robustness for the lane line attribute detections in various scenarios, the detection time is short, and the detection results are accurate.

After obtaining the pavement training image set, the neural network can be trained according to the following process.

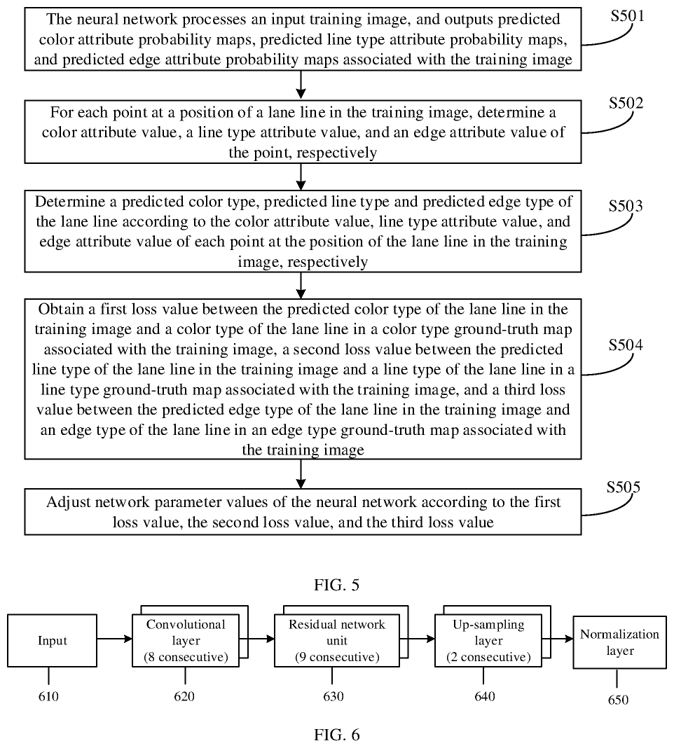

FIG. 5 is a flowchart illustrating a method of training a neural network for detecting an attribute of a lane line according to an example of the present disclosure. As shown in FIG. 5, the training process of the neural network may include the following steps.

S501, the neural network processes an input training image, and outputs predicted color attribute probability maps, predicted line type attribute probability maps, and predicted edge attribute probability maps associated with the training image.

The training image is included in the pavement training image set.

The predicted color attribute probability maps, predicted line type attribute probability maps, and predicted edge attribute probability maps are the actual current output of the neural network.

S502, for each point at a position of a lane line in the training image, a color attribute value, a line type attribute value, and an edge attribute value of the point are determined respectively.

S503, a predicted color type, predicted line type and predicted edge type of the lane line are determined according to the color attribute value, line type attribute value, and edge attribute value of each point at the position of the lane line in the training image, respectively.

The predicted color type refers to the color attribute value of the lane line obtained from the probability maps output by the neural network. The predicted line type refers to the line type attribute value of the lane line obtained from the probability maps output by the neural network. The predicted edge type refers to the edge attribute value of the lane line obtained from the probability maps output by the neural network.

In steps S502-S503, color, line type, and edge dimensions may be processed separately to determine the predicted color type, predicted line type, and predicted edge type of the lane line in the training image, respectively.

The specific method for determining the color attribute value of each point at the position of the lane line in the training image and determining the predicted color type of the lane line according to the color attribute values of respective points can refer to the aforementioned steps S301-S303, steps S304-S306, or, steps S401-S403, which will not be repeated here.

The specific method for determining the line type attribute value of each point at the position of the lane line in the training image and determining the predicted line type of the lane line according to the line type attribute values of the respective points can refer to the aforementioned steps S301-S303, steps S304-S306, or, steps S401-S403, which will not be repeated here.

The neural network determines the line type attribute or the edge attribute of each point at a position in the lane line by using the entire pavement image for determining whether the lane line is dashed or solid, and then gives the probability of a point on the lane line belonging to a dashed line or a solid line. This is because each pixel in a feature map extracted from the pavement image by the neural network aggregates information of a large area in the pavement image, so it can determine the line type or edge type of the lane line.

The specific method for determining the edge attribute value of each point at the position of the lane line in the training image and determining the predicted edge type of the lane line according to the edge attribute values of the respective points can refer to the aforementioned steps S301-S303, steps S304-S306, or, steps S401-S403, which will not be repeated here.

S504, a first loss value between the predicted color type of the lane line in the training image and a color type of the lane line in a color type ground-truth map associated with the training image is obtained, a second loss value between the predicted line type of the lane line in the training image and a line type of the lane line in a line type ground-truth map associated with the training image is obtained, and a third loss value between the predicted edge type of the lane line in the training image and an edge type of the lane line in an edge type ground-truth map associated with the training image is obtained.

The color type ground-truth map expresses color of the training image using logical algebra, and the color type ground-truth map is obtained based on the annotation information as the color type of the training image. The line type ground-truth map expresses a line type of the training image using logical algebra, and the line type ground-truth map is obtained based on the annotation information as the line type of the training image. The edge type ground-truth map expresses an edge type of the training image using logical algebra, and the edge type ground-truth map is obtained based on the annotation information as the edge type of the training image.

In an example, a loss function may be used to calculate the first loss value between the predicted color type and the color type in the color type ground-truth map, the second loss value between the predicted line type and the line type in the line type ground-truth map, and the third loss value between the predicted edge type and the edge type in the edge type ground-truth map.

S505: network parameter values of the neural network are adjusted according to the first loss value, the second loss value, and the third loss value.

For example, the network parameters of the neural network may include convolutional kernel size, weight information, and so on.

In this step, the loss values can be back-propagated in the neural network by gradient back-propagation, so as to adjust the network parameter values of the neural network.

After this step, an iterative process of training is completed, and new parameter values of the neural network are obtained.

In an example, based on the new parameter values of the neural network, steps S501-S504 can be continued until the first loss value is within a preset loss range, the second loss value is within the preset loss range, and the third loss value is within the preset loss range. At this time, the parameter values of the neural network are obtained as optimized parameter values, and the training of the neural network ends.

In another example, based on the new parameter values of the neural network, steps S501-S504 can be continued until a sum of the first loss value, the second loss value, and the third loss value is within another preset loss range. At this time, the parameter values of the neural network are obtained as optimized parameter values, and the training of the neural network ends.

In still another example, it is also possible to determine whether the training of the neural network has ended based on a gradient descent algorithm or other common algorithms in the neural network field.

Exemplarily, one training image can be used to train the neural network at a time, or multiple training images can also be used to train the neural network at a time.

In an example, the neural network may be a convolutional neural network, which may include one or more convolutional layers, one or more residual network units, one or more up-sampling layers, and one or more normalization layers. The order of the convolutional layer and the residual network unit can be flexibly set as needed, and the number of each layer can also be flexibly set as needed.

For example, the convolutional neural network may include connected 6 to 10 convolutional layers, 7 to 12 connected residual network units, and 1 to 4 up-sampling layers. When the convolutional neural network with this specific structure is used for lane line attribute detection, the convolutional neural network can meet the requirements of multi-scene or complex scene lane line attribute detection, thereby making the detection result more robust.

In an example, the convolutional neural network may include 8 connected convolutional layers, 9 connected residual network units, and 2 connected up-sampling layers.

FIG. 6 is a schematic structural diagram illustrating a convolutional neural network according to an example of the present disclosure. As shown in FIG. 6, after a pavement image is input into 610, the image first passes through 8 consecutive convolutional layers 620 of the convolutional neural network. After the 8 consecutive convolutional layers 620, 9 consecutive residual network units 630 are included. After the 9 consecutive residual network units 630, 2 consecutive up-sampling layers 640 are included. And after the 2 consecutive up-sampling layers 640, a normalization layer 650 is included. The normalization layer 650 finally outputs the probability maps.

Exemplarily, each of the residual network units 630 may include 256 filters, and each layer may include 128 3*3 and 128 1*1 filters.

After completing the training of the neural network through the above process, the following procedure can be followed when using the neural network to output the probability maps.

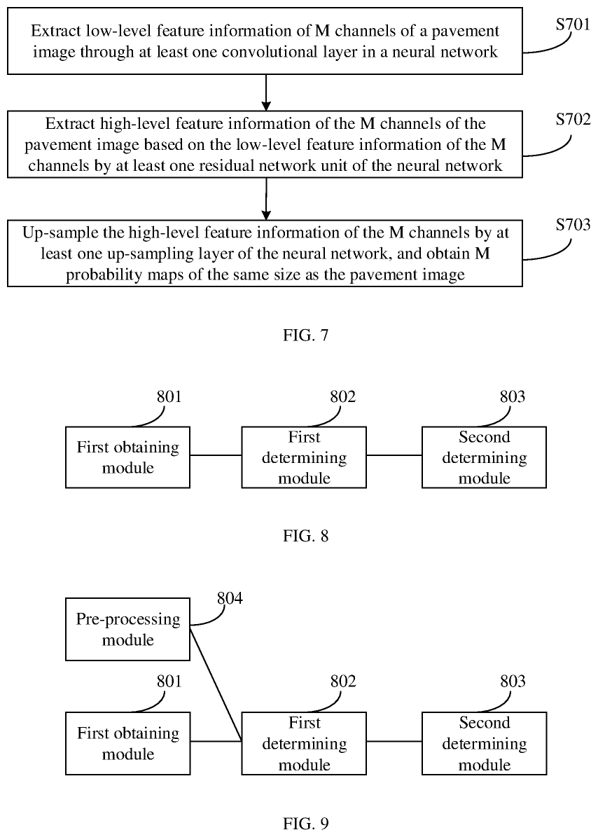

FIG. 7 is a flowchart illustrating a process of performing pavement image processing by a neural network for detecting an attribute of a lane line according to an example of the present disclosure. As shown in FIG. 7, a process of obtaining the probability maps by a neural network is as followings.

S701, low-level feature information of M channels of a pavement image is extracted through at least one convolutional layer in the neural network.

M is the number of probability maps obtained in step S202. In an example, if the probability maps include the set of color attribute probability maps and the set of line type attribute probability maps, M is a sum of N1 and N2. In another example, if the probability maps include the set of color attribute probability maps, the set of line type attribute probability maps, and the set of edge attribute probability maps, M is a sum of N1, N2, and N3.

The convolutional layer can reduce resolution of the pavement image while retain low-level features of the pavement image. Exemplarily, the low-level feature information of the pavement image may include edge information, straight line information, curve information, etc., in the image.

Taking the probability maps including the set of color attribute probability maps, the set of line type attribute probability maps and the set of edge attribute probability maps as an example, each of the M channels of the pavement image corresponds to a color attribute, a line type attribute or an edge attribute.

S702, high-level feature information of the M channels of the pavement image is extracted based on the low-level feature information of the M channels by at least one residual network unit of the neural network.

The high-level feature information of the M channels of the pavement image extracted by the residual network unit includes semantic features, contours, overall structure, and so on.

S703, the high-level feature information of the M channels is up-sampled by at least one up-sampling layer of the neural network, and M probability maps of the same size as the pavement image are obtained.

Through the up-sampling process in the up-sampling layer, an image can be restored to an original size of the image, wherein the original size is a size when the image input the neural network. In this step, after up-sampling the high-level feature information of the M channels, M probability maps that are as large as the pavement image input to the neural network can be obtained.

It should be noted that the low-level feature information and the high-level feature information described in the examples of the present disclosure are relative concepts under a specific neural network. For example, in a deep neural network, comparing features extracted by a network layer with a shallow depth with features extracted by a network layer with a deeper depth, features extracted by the former belong to the low-level feature information, and features extracted by the latter belong to the high-level feature information.

In an example, the neural network may further include a normalization layer after the up-sampling layer, and the M probability maps are output through the normalization layer.

Exemplarily, feature maps of the pavement image are obtained after the up-sampling process, and a value of each pixel in each feature map is normalized, such that the value of each pixel in each feature map is in the range of 0 to 1, resulting in M probability maps.

Exemplarily, a normalization method is to first determine a maximum value of pixels in the feature map, and then divide a value of each pixel by the maximum value, such that the value of each pixel in the feature map is in the range of 0 to 1.

It should be noted that, in the examples of the present disclosure, the execution order of steps S701 and S702 is not limited, that is, S701 may be executed first and then S702 is executed, or S702 may be executed first and then S701 is executed.

As an example implementation manner, before the pavement image is input to the neural network in step S202, distortion of the pavement image may be eliminated first, so as to further improve the accuracy of the neural network output result.

FIG. 8 is a module structural diagram illustrating a lane line attribute detection apparatus according to an example of the present disclosure. As shown in FIG. 8, the apparatus includes: a first obtaining module 801, a first determining module 802, and a second determining module 803.

The first obtaining module 801 is configured to obtain a pavement image collected by an image acquisition device mounted on an intelligent device.

The first determining module 802 is configured to determine probability maps according to the pavement image, wherein the probability maps include at least two of: a set of color attribute probability maps, a set of line type attribute probability maps, and a set of edge attribute probability maps. There are N1 color attribute probability maps, N2 line type attribute probability maps, and N3 edge attribute probability maps, and N1, N2, and N3 are all integers greater than 0. Each of the color attribute probability maps represents a probability of each point in the pavement image belonging to a color corresponding to the color attribute probability map, each of the line type attribute probability maps represents a probability of each point in the pavement image belonging to a line type corresponding to the line type attribute probability map, and each of the edge attribute probability maps represents a probability of each point in the pavement image belonging to an edge corresponding to the edge attribute probability map.

The second determining module 803 is configured to determine an attribute of a lane line in the pavement image according to the probability maps.

In another example, the N1 color attribute probability maps correspond to colors including at least one of: white, yellow, or blue.

In another example, the N2 line type attribute probability maps correspond to line types including at least one of: a dashed line, a solid line, a double dashed line, a double solid line, a dashed solid line, a solid dashed line, a triple dashed line, or a dashed solid dashed line.

In another example, the N3 edge attribute probability maps correspond to edges including at least one of: a curb type edge, a fence type edge, a wall or flower bed type edge, a virtual edge, or non-edge.

In another example, the probability maps include a set of first attribute probability maps and a set of second attribute probability maps, the set of first attribute probability maps and the set of second attribute probability maps are two sets in the set of color attribute probability maps, the set of line type attribute probability maps, and the set of edge attribute probability maps, and the set of first attribute probability maps is different set with the set of second attribute probability maps.

The second determining module 803 is specifically configured to: for each point at a position of the lane line in the pavement image, determine a probability value of the point at a corresponding position in each of L first attribute probability maps; for the point, take a first attribute value corresponding to a first attribute probability map with a largest probability value of the point as a first attribute value of the point; determine a first attribute value of the lane line according to first attribute values of respective points at positions of the lane line in the pavement image; for each point at a position of the lane line in the pavement image, determine a probability value of the point at a corresponding position in each of S second attribute probability maps; for the point, take a second attribute value corresponding to a second attribute probability map with a largest probability value of the point as a second attribute value of the point; determine a second attribute value of the lane line according to second attribute values of respective points at the positions of the lane line in the pavement image; combine the first attribute value of the lane line and the second attribute value of the lane line; and take the combined attribute value as a value of the attribute of the lane line. In response to that the set of first attribute probability maps is the set of color attribute probability maps, L equals N1, and a first attribute is a color attribute; in response to that the set of first attribute probability maps is the set of line type attribute probability maps, L equals N2, and the first attribute is a line type attribute; in response to that the set of first attribute probability maps is the set of edge attribute probability maps, L equals N3, and the first attribute is an edge attribute; in response to that the set of second attribute probability maps is the set of color attribute probability maps, S equals N1, and a second attribute is the color attribute; in response to that the set of second attribute probability maps is the set of line type attribute probability maps, S equals N2, and the second attribute is the line type attribute; and in response to that the set of second attribute probability maps is the set of edge attribute probability maps, S equals N3, and the second attribute is the edge attribute.

In another example, determining, by the second determining module 803, the first attribute value of the lane line according to the first attribute values of the respective points at the positions of the lane line in the pavement image includes: in response to that the first attribute values of the respective points at the positions of the lane line are different, taking a first attribute value of points, which, among the respective points at the positions of the lane line, belong to a greatest number of points with an identical first attribute value, as the first attribute value of the lane line.

In another example, determining, by the second determining module 803, the first attribute value of the lane line according to the first attribute values of the respective points at the positions of the lane line in the pavement image includes: in response to that the first attribute values of the respective points at the positions of the lane line are the same, taking a first attribute of a point at a position of the lane line as the first attribute value of the lane line.

In another example, determining, by the second determining module 803, by the second determining module, the second attribute value of the lane line according to the second attribute values of the respective points at the positions of the lane line in the pavement image includes: in response to that the second attribute values of the respective points at the positions of the lane line are different, taking a second attribute value of points, which, among the respective points at the positions of the lane line, belong to a greatest number of points with an identical second attribute value, as the second attribute value of the lane line.

In another example, determining, by the second determining module 803, the second attribute value of the lane line according to the second attribute values of the respective points at the positions of the lane line in the pavement image includes: in response to that the second attribute values of the respective points at the positions of the lane line are the same, taking a second attribute of a point at a position of the lane line as the second attribute value of the lane line.

In another example, the probability maps further include a set of third attribute probability maps, the set of third attribute probability maps is one set in the set of color attribute probability maps, the set of line type attribute probability maps, and the set of edge attribute probability maps, and any two of the set of first attribute probability maps, the set of second attribute probability maps, and the set of third attribute probability maps are sets of probability maps with different attributes.

The second determining module 803 is further configured to: before combining the first attribute value of the lane line and the second attribute value of the lane line, for each point at a position of the lane line in the pavement image, determine a probability value of the point at a corresponding position in each of U third attribute probability maps; for the point, take a third attribute value corresponding to a third attribute probability map with a largest probability value of the point as a third attribute value of the point; and determine a third attribute value of the lane line according to third attribute values of the respective points at the positions of the lane line in the pavement image. In response to that the set of third attribute probability maps is the set of color attribute probability maps, U equals N1, and a third attribute is the color attribute; in response to that the set of third attribute probability maps is the set of line type attribute probability maps, U equals N2, and the third attribute is the line type attribute; and in response to that the set of third attribute probability maps is the set of edge attribute probability maps, U equals N3, and the third attribute is the edge attribute. Combining, by the second determining module 803, the first attribute value of the lane line and the second attribute value of the lane line includes: combining the first attribute value of the lane line, the second attribute value of the lane line, and the third attribute value of the lane line.

In another example, determining, by the second determining module 803, the third attribute value of the lane line according to the third attribute values of the respective points at the positions of the lane line in the pavement image includes: in response to that the third attribute values of the respective points at the positions of the lane line are different, taking a third attribute value of points, which, among the respective points at the positions of the lane line, belong to a greatest number of points with an identical third attribute value, as the third attribute value of the lane line.

In another example, determining, by the second determining module 803, the third attribute value of the lane line according to the third attribute values of the respective points at the positions of the lane line in the pavement image includes: in response to that the third attribute values of the respective points at the positions of the lane line are the same, taking a third attribute of a point at a position of the lane line as the third attribute value of the lane line.

In another example, the first determining module 802 is specifically configured to: input the pavement image into a neural network which outputs the probability maps. The neural network is obtained by supervised training using a pavement training image set including annotation information as color type, line type, and edge type.

FIG. 9 is a module structural diagram illustrating a lane line attribute detection apparatus according to an example of the present disclosure. As shown in FIG. 9, the apparatus further includes a pre-processing module 804 configured to eliminate distortion of the pavement image.

It should be noted that, the division of each module of the above apparatuses is merely a division of a logical function, and in practical implementation, all or part of the modules may be integrated into one physical entity, or may be physically separated. These modules may all be implemented in the form of software invoked by the processing element; or all of the modules may be implemented in the form of hardware; or some of the modules may be implemented in the form of a processing element invoking software, and some of the modules may be implemented in the form of hardware. For example, the determining module may be a separately set processing element, or may be integrated into a certain chip of the apparatus for implementation, and may also be stored in a memory of the apparatus in the form of a program code, invoked by a certain processing element of the apparatus and executed functions of the determining module. The implementation of other modules is similar. In addition, all or part of these modules may be integrated together or may be implemented independently. The processing element described herein may be an integrated circuit having a processing capability of a signal. In the implementation process, each step or each module of the above methods may be completed by an integrated logic circuit of hardware in a processor element or instructions in the form of software.

For example, the above modules may be one or more integrated circuits configured to implement the above methods, such as one or more application specific integrated circuits (ASICs), or one or more digital signal processors (DSPs), or one or more field programmable gate arrays (FPGAs), etc. For another example, when one of the above modules is implemented in the form of program codes invoked by a processing element, the processing element may be a general-purpose processor, such as a central processing unit (CPU) or other processors that can invoke program codes. For another example, these modules can be integrated together and implemented in the form of a system-on-a-chip (SOC).

In the examples, all or part may be implemented by software, hardware, firmware, or any combination thereof. When implemented in software, it can be implemented in whole or in part in the form of a computer program product. The computer program product includes one or more computer instructions. When computer program instructions are loaded and executed on a computer, the processes or function according to the examples of the present disclosure are generated in whole or in part. The computer can be a general-purpose computer, a dedicated computer, a computer network, or other programmable devices. Computer instructions can be stored in a computer-readable storage medium or transmitted from one computer-readable storage medium to another computer-readable storage medium, for example, the computer instructions can be transmitted from a website site, a computer, a server or a data center via wire (For example, coaxial cable, optical fiber, digital subscriber line (DSL)) or wireless (for example, infrared, wireless, microwave, etc.) to another website, another computer, another server, or another data center. The computer-readable storage medium can be any available medium that can be accessed by a computer or a data storage device, such as a server, a data center, etc., including one or more available media integrations. The medium can be a magnetic medium (e.g., floppy disk, hard disk, magnetic tape), an optical medium (e.g., DVD), a semiconductor medium (e.g., solid state disk (SSD)), and so on.

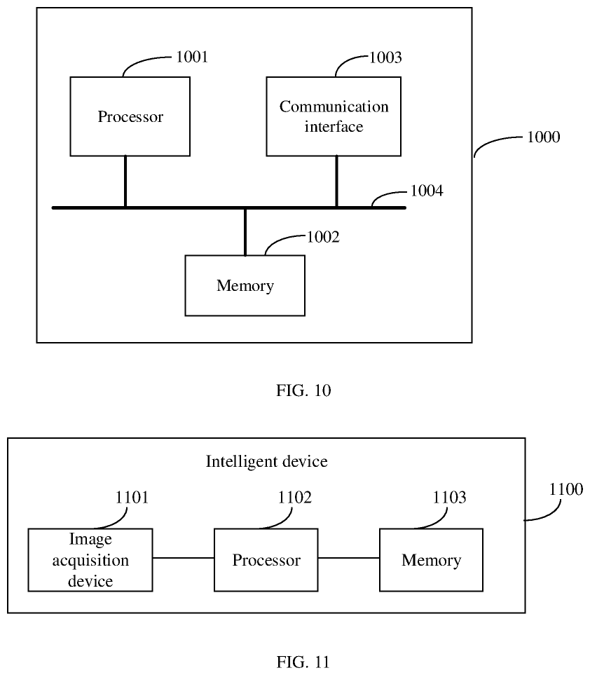

FIG. 10 is a schematic structural diagram illustrating an electronic device according to an example of the present disclosure. As shown in FIG. 10, the electronic device 1000 may include a processor 1001, a memory 1002, a communication interface 1003, and a system bus 1004. The memory 1002 and the communication interface 1003 are connected to the processor 1001 through the system bus 1004 and communicate with each other. The memory 1002 stores instructions executable by a computer, the communication interface 1003 is configured to communicate with other devices, and the processor 1001 executes the instructions to implement the lane line attribute detection methods provided by examples of the present disclosure.

The system bus in FIG. 10 may be a peripheral component interconnect (PCI) bus, an extended industry standard architecture (EISA) bus, or the like. The system bus can be divided into an address bus, a data bus, a control bus, etc. For ease of representation, only one thick line is represented in this figure, which does not indicate that there is only one bus or one type of bus. The communication interface is used to realize the communication between a database access device and other devices (such as clients, read-write libraries, and read-only libraries). The memory may include random access memory (RAM), and may also include non-volatile memory, for example, at least one disk memory.

The processor may be a general-purpose processor, including a CPU, a network processor (NP), etc. The processor may also be a DSP, an ASIC, an FPGA or other programmable logic devices, discrete gates, transistor logic devices, or discrete hardware components.

FIG. 11 is a schematic structural diagram illustrating an intelligent device according to an example of the present disclosure. As shown in FIG. 11, an intelligent device 1100 of this example includes: an image acquisition device 1101, a processor 1102, and a memory 1103.

As shown in FIG. 11, in actual use, the image acquisition device 1101 collects a pavement image and sends the pavement image to the processor 1102. The processor 1102 invokes and executes the program instructions in the memory 1103 to detect an attribute of a lane line in the pavement image, and outputs prompt information or performs driving control on the intelligent device according to the detected attribute of the lane line.

The intelligent device in this example can be an intelligent device capable of driving on the road, such as an intelligent driving vehicle, a robot, a guidance device for the blind, etc. The intelligent driving vehicle may be an automatic driving vehicle or a vehicle having an assisted driving system.

The prompt information may include lane departure warning, a lane keeping prompt, a speed changing prompt, a driving direction changing prompt, a lane keeping prompt, a vehicle lamp status changing prompt, and so on.

The driving control may include: braking, changing a driving speed, changing a driving direction, keeping a lane, changing vehicle lamp status, switching a driving mode, etc., wherein switching the driving mode may be switching between assisted driving and automatic driving, for example, switching assisted driving to automatic driving.

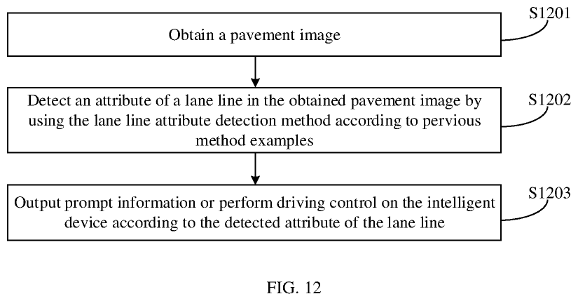

FIG. 12 is a flowchart illustrating an intelligent driving method according to an example of the present disclosure. On the basis of the above examples, an example of the present disclosure also provides an intelligent driving method, the method may be applicable to the intelligent device described in FIG. 11. As shown in FIG. 12, the method includes the followings.

S1201, a pavement image is obtained.

S1202, an attribute of a lane line in the obtained pavement image is detected by using the above lane line attribute detection methods.

S1203, prompt information is output or driving control is performed on the intelligent device according to the detected attribute of the lane line.

The execution subject of this example can be a movable intelligent device, such as an intelligent driving vehicle, a robot, a guidance device for the blind, etc. The intelligent driving vehicle may be an automatic driving vehicle or a vehicle having an assisted driving system.

The intelligent driving in this example may include assisted driving, automatic driving, and/or a driving mode switching between assisted driving and automatic driving.

A result of the lane line attribute detection of the pavement image is obtained by the lane line attribute detection method of the above examples, and the specific process can be referred to the description of the above examples, which will not be repeated here.

The intelligent device executes the above lane line attribute detection methods to obtain the result of the lane line attribute detection of the pavement image, and outputs prompt information and/or performs movement control according to the result of the lane line attribute detection of the pavement image.

The prompt information may include lane departure warning, a lane keeping prompt, a speed changing prompt, a driving direction changing prompt, a lane keeping prompt, a vehicle lamp status changing prompt, and so on.

The driving control may include: braking, changing a driving speed, changing a driving direction, keeping a lane, etc.

The present example provides a driving control method, in which the intelligent device obtains the lane line attribute detection result of the pavement image and outputs the prompt information or performs the driving control on the intelligent device based on the lane line attribute detection result of the pavement image, thereby improving safety and reliability of the intelligent device.

In an embodiment, examples of the present disclosure further provide a non-transitory storage medium, and the storage medium stores instructions. When the instructions are executed on a computer, the instructions cause the computer to execute the lane line attribute detection methods provided by the examples of the present disclosure.

In an embodiment, examples of the present disclosure further provide a chip for executing instructions, and the chip is configured to execute the lane line attribute detection methods provided by the examples of the present disclosure.

The present disclosure also provides a program product, the program product includes a computer program stored in a storage medium. When at least one processor read the computer program from the storage medium, the at least one processor executes the computer program to implement the lane line attribute detection methods provided by the examples of the present disclosure.

In examples of the present disclosure, “at least one” refers to one or more, “a plurality” refers to two or more. “And/or”, describing association relationships of associated objects, indicates that there may be three relationships, for example, A and/or B, which may indicate that: A exists separately, B exists separately, or A and B exist at the same time, wherein A and B can be singular or plural. The character “/” generally indicates that an “or” relationship for associated objects before and after the character; and in a formula, the character “/” indicates that a “division” relationship for the associated objects before and after the character. “At least one of the following items” or similar expressions refers to any combination of these items, including any combination of single item or plural items. For example, at least one of a, b, or c may be expressed as: a, b, c, a and b, a and c, b and c, or a and b and c, wherein a, b, and c may be single or plural.

It can be understood that various numbers involved in the examples of the present disclosure are merely distinguished for convenience of description, and are not intended to limit the scope of the examples of the present disclosure.

It can be understood that, in the examples of the present disclosure, the serial numbers of the above processes do not mean an execution order, and the execution order of the processes should be determined by function and built-in logic thereof, and should not be limited to the implementation processes of the examples of the present disclosure.

Finally, it should be noted that, the above examples are merely used for describing the technical solutions of the present disclosure, and are not limited thereto. Although the present disclosure has been described in detail with reference to the foregoing examples, it should be understood by those skilled in the art that the technical solutions described in the foregoing examples can be modified or equivalent replacements can be made to some or all of the technical features, while such modifications or replacements do not take the essence of the corresponding technical solutions out of the scope of the technical solutions of the present disclosure.

1. A lane line attribute detection method, comprising:
obtaining a pavement image collected by an image acquisition device mounted on an intelligent device;
determining probability maps according to the pavement image, wherein the probability maps comprise at least two of: a set of color attribute probability maps, a set of line type attribute probability maps, and a set of edge attribute probability maps, wherein,
there are N1 color attribute probability maps, N2 line type attribute probability maps, and N3 edge attribute probability maps, and N1, N2, and N3 are all integers greater than 0;
each of the color attribute probability maps represents a probability of each point in the pavement image belonging to a color corresponding to the color attribute probability map,
each of the line type attribute probability maps represents a probability of each point in the pavement image belonging to a line type corresponding to the line type attribute probability map, and
each of the edge attribute probability maps represents a probability of each point in the pavement image belonging to an edge corresponding to the edge attribute probability map; and
determining an attribute of a lane line in the pavement image according to the probability maps.

2. The method according to claim 1, wherein the N1 color attribute probability maps correspond to colors comprising at least one of:
white,
yellow, or
blue.

3. The method according to claim 1, wherein the N2 line type attribute probability maps correspond to line types comprising at least one of:
a dashed line,
a solid line,
a double dashed line,
a double solid line,
a dashed solid line,
a solid dashed line,
a triple dashed line, or
a dashed solid dashed line.

4. The method according to claim 1, wherein the N3 edge attribute probability maps correspond to edges comprising at least one of:
a curb type edge,
a fence type edge,
a wall or flower bed type edge,
a virtual edge, or
non-edge.

5. The method according to claim 1,
wherein the probability maps comprise a set of first attribute probability maps and a set of second attribute probability maps, the set of first attribute probability maps and the set of second attribute probability maps are two sets selected from: the set of color attribute probability maps, the set of line type attribute probability maps, and the set of edge attribute probability maps, and the set of first attribute probability maps is different from the set of second attribute probability maps; and
wherein determining the attribute of the lane line in the pavement image according to the probability maps comprises:
for each point at a position of the lane line in the pavement image, determining a probability value of the point at a corresponding position in each of L first attribute probability maps;
for the point, taking a first attribute value corresponding to a first attribute probability map with a largest probability value of the point as a first attribute value of the point;
determining a first attribute value of the lane line according to first attribute values of respective points at positions of the lane line in the pavement image;
for each point at a position of the lane line in the pavement image, determining a probability value of the point at a corresponding position in each of S second attribute probability maps;
for the point, taking a second attribute value corresponding to a second attribute probability map with a largest probability value of the point as a second attribute value of the point;
determining a second attribute value of the lane line according to second attribute values of respective points at the positions of the lane line in the pavement image;
combining the first attribute value of the lane line and the second attribute value of the lane line; and
taking the combined attribute value as a value of the attribute of the lane line;
wherein, in response to that the set of first attribute probability maps is the set of color attribute probability maps, L equals N1, and a first attribute is a color attribute;
in response to that the set of first attribute probability maps is the set of line type attribute probability maps, L equals N2, and the first attribute is a line type attribute;
in response to that the set of first attribute probability maps is the set of edge attribute probability maps, L equals N3, and the first attribute is an edge attribute;
in response to that the set of second attribute probability maps is the set of color attribute probability maps, S equals N1, and a second attribute is the color attribute;
in response to that the set of second attribute probability maps is the set of line type attribute probability maps, S equals N2, and the second attribute is the line type attribute; and
in response to that the set of second attribute probability maps is the set of edge attribute probability maps, S equals N3, and the second attribute is the edge attribute.

6. The method according to claim 5, wherein determining the first attribute value of the lane line according to the first attribute values of the respective points at the positions of the lane line in the pavement image comprises:
in response to that the first attribute values of the respective points at the positions of the lane line are different, taking a first attribute value of points which are among the respective points at the positions of the lane line and belong to a greatest number of points with an identical first attribute value, as the first attribute value of the lane line.

7. The method according to claim 5, wherein determining the first attribute value of the lane line according to the first attribute values of the respective points at the positions of the lane line in the pavement image comprises:
in response to that the first attribute values of the respective points at the positions of the lane line are the same, taking a first attribute of a point at a position of the lane line as the first attribute value of the lane line.

8. The method according to claim 5, wherein determining the second attribute value of the lane line according to the second attribute values of the respective points at the positions of the lane line in the pavement image comprises:
in response to that the second attribute values of the respective points at the positions of the lane line are different, taking a second attribute value of points which are among the respective points at the positions of the lane line and belong to a greatest number of points with an identical second attribute value, as the second attribute value of the lane line.

9. The method according to claim 5, wherein determining the second attribute value of the lane line according to the second attribute values of the respective points at the positions of the lane line in the pavement image comprises:
in response to that the second attribute values of the respective points at the positions of the lane line are the same, taking a second attribute of a point at a position of the lane line as the second attribute value of the lane line.

10. The method according to claim 5,
wherein the probability maps further comprise a set of third attribute probability maps, the set of third attribute probability maps is one set selected from: the set of color attribute probability maps, the set of line type attribute probability maps, and the set of edge attribute probability maps, and any two of the set of first attribute probability maps, the set of second attribute probability maps, and the set of third attribute probability maps are sets of probability maps with different attributes; and
before combining the first attribute value of the lane line and the second attribute value of the lane line, the method further comprises:
for each point at a position of the lane line in the pavement image, determining a probability value of the point at a corresponding position in each of U third attribute probability maps;
for the point, taking a third attribute value corresponding to a third attribute probability map with a largest probability value of the point as a third attribute value of the point; and
determining a third attribute value of the lane line according to third attribute values of the respective points at the positions of the lane line in the pavement image;
wherein, in response to that the set of third attribute probability maps is the set of color attribute probability maps, U equals N1, and a third attribute is the color attribute;
in response to that the set of third attribute probability maps is the set of line type attribute probability maps, U equals N2, and the third attribute is the line type attribute; and
in response to that the set of third attribute probability maps is the set of edge attribute probability maps, U equals N3, and the third attribute is the edge attribute; and
wherein combining the first attribute value of the lane line and the second attribute value of the lane line comprises:
combining the first attribute value of the lane line, the second attribute value of the lane line, and the third attribute value of the lane line.

11. The method according to claim 10, wherein determining the third attribute value of the lane line according to the third attribute values of the respective points at the positions of the lane line in the pavement image comprises:
in response to that the third attribute values of the respective points at the positions of the lane line are different, taking a third attribute value of points which are among the respective points at the positions of the lane line and belong to a greatest number of points with an identical third attribute value, as the third attribute value of the lane line.

12. The method according to claim 10, wherein determining the third attribute value of the lane line according to the third attribute values of the respective points at the positions of the lane line in the pavement image comprises:
in response to that the third attribute values of the respective points at the positions of the lane line are the same, taking a third attribute of a point at a position of the lane line as the third attribute value of the lane line.

13. The method according to claim 1, wherein determining the probability maps according to the pavement image comprises:
inputting the pavement image into a neural network which outputs the probability maps;
wherein, the neural network is obtained by supervised training using a pavement training image set comprising annotation information of color type, line type, and edge type.

14. The method according to claim 13, wherein before inputting the pavement image into the neural network, the method further comprises:
eliminating distortion of the pavement image.

15. An electronic device, comprising:
a memory for storing computer readable program instructions, and
a processor configured to invoke and execute the computer readable program instructions in the memory to implement the method according to claim 1.

16. An intelligent driving method, being applicable to an intelligent device, comprising:
obtaining a pavement image;
detecting an attribute of a lane line in the obtained pavement image by using the lane line attribute detection method according to claim 1; and
outputting prompt information or performing driving control on the intelligent device according to the detected attribute of the lane line.

17. An intelligent device, comprising:
an image acquisition device configured to collect a pavement image;
a memory configured to store computer readable program instructions, wherein the computer readable program instructions are executed to:
obtain a pavement image collected by an image acquisition device mounted on an intelligent device;
determine probability maps according to the pavement image, wherein the probability maps comprise at least two of: a set of color attribute probability maps, a set of line type attribute probability maps, and a set of edge attribute probability maps, wherein,
there are N1 color attribute probability maps, N2 line type attribute probability maps, and N3 edge attribute probability maps, and N1, N2, and N3 are all integers greater than 0;
each of the color attribute probability maps represents a probability of each point in the pavement image belonging to a color corresponding to the color attribute probability map,
each of the line type attribute probability maps represents a probability of each point in the pavement image belonging to a line type corresponding to the line type attribute probability map, and
each of the edge attribute probability maps represents a probability of each point in the pavement image belonging to an edge corresponding to the edge attribute probability map; and
determine an attribute of a lane line in the pavement image according to the probability maps; and
a processor configured to
detect an attribute of a lane line in the pavement image by executing the program instructions stored in the memory according to the pavement image collected by the image acquisition device, and
output prompt information or perform driving control on the intelligent device according to the detected attribute of the lane line.

18. The intelligent device according to claim 17,
wherein the probability maps comprise a set of first attribute probability maps and a set of second attribute probability maps, the set of first attribute probability maps and the set of second attribute probability maps are two sets selected from: the set of color attribute probability maps, the set of line type attribute probability maps, and the set of edge attribute probability maps, and the set of first attribute probability maps is different from the set of second attribute probability maps; and
wherein determining the attribute of the lane line in the pavement image according to the probability maps comprises:
for each point at a position of the lane line in the pavement image, determining a probability value of the point at a corresponding position in each of L first attribute probability maps;
for the point, taking a first attribute value corresponding to a first attribute probability map with a largest probability value of the point as a first attribute value of the point;
determining a first attribute value of the lane line according to first attribute values of respective points at positions of the lane line in the pavement image;
for each point at a position of the lane line in the pavement image, determining a probability value of the point at a corresponding position in each of S second attribute probability maps;
for the point, taking a second attribute value corresponding to a second attribute probability map with a largest probability value of the point as a second attribute value of the point;
determining a second attribute value of the lane line according to second attribute values of respective points at the positions of the lane line in the pavement image;
combining the first attribute value of the lane line and the second attribute value of the lane line; and
taking the combined attribute value as a value of the attribute of the lane line;
wherein, in response to that the set of first attribute probability maps is the set of color attribute probability maps, L equals N1, and a first attribute is a color attribute;
in response to that the set of first attribute probability maps is the set of line type attribute probability maps, L equals N2, and the first attribute is a line type attribute;
in response to that the set of first attribute probability maps is the set of edge attribute probability maps, L equals N3, and the first attribute is an edge attribute;
in response to that the set of second attribute probability maps is the set of color attribute probability maps, S equals N1, and a second attribute is the color attribute;
in response to that the set of second attribute probability maps is the set of line type attribute probability maps, S equals N2, and the second attribute is the line type attribute; and
in response to that the set of second attribute probability maps is the set of edge attribute probability maps, S equals N3, and the second attribute is the edge attribute.

19. The intelligent device according to claim 18,
wherein the probability maps further comprise a set of third attribute probability maps, the set of third attribute probability maps is one set selected from: the set of color attribute probability maps, the set of line type attribute probability maps, and the set of edge attribute probability maps, and any two of the set of first attribute probability maps, the set of second attribute probability maps, and the set of third attribute probability maps are sets of probability maps with different attributes; and
before combining the first attribute value of the lane line and the second attribute value of the lane line, the program instructions are further executed to:
for each point at a position of the lane line in the pavement image, determine a probability value of the point at a corresponding position in each of U third attribute probability maps;
for the point, take a third attribute value corresponding to a third attribute probability map with a largest probability value of the point as a third attribute value of the point; and
determine a third attribute value of the lane line according to third attribute values of the respective points at the positions of the lane line in the pavement image;
wherein, in response to that the set of third attribute probability maps is the set of color attribute probability maps, U equals N1, and a third attribute is the color attribute;
in response to that the set of third attribute probability maps is the set of line type attribute probability maps, U equals N2, and the third attribute is the line type attribute; and
in response to that the set of third attribute probability maps is the set of edge attribute probability maps, U equals N3, and the third attribute is the edge attribute; and
wherein combining the first attribute value of the lane line and the second attribute value of the lane line comprises:
combining the first attribute value of the lane line, the second attribute value of the lane line, and the third attribute value of the lane line.

20. A non-transitory computer readable storage medium storing a computer readable program, wherein the computer readable program is configured to:
obtain a pavement image collected by an image acquisition device mounted on an intelligent device;
determine probability maps according to the pavement image, wherein the probability maps comprise at least two of: a set of color attribute probability maps, a set of line type attribute probability maps, and a set of edge attribute probability maps, wherein,
there are N1 color attribute probability maps, N2 line type attribute probability maps, and N3 edge attribute probability maps, and N1, N2, and N3 are all integers greater than 0;
each of the color attribute probability maps represents a probability of each point in the pavement image belonging to a color corresponding to the color attribute probability map,
each of the line type attribute probability maps represents a probability of each point in the pavement image belonging to a line type corresponding to the line type attribute probability map, and
each of the edge attribute probability maps represents a probability of each point in the pavement image belonging to an edge corresponding to the edge attribute probability map; and
determine an attribute of a lane line in the pavement image according to the probability maps.
